(19) United States
(12) Patent Application Publication
(10) Pub. No.: US 2023/0174363 A1
(43) Pub. Date: Jun. 8, 2023

(54) REVOLVING BEVERAGE HOLDER

(71) Applicant: Starbucks Corporation, Seattle, WA (US)

(72) Inventor: Michael R. Cummer, Seattle, WA (US)

(21) Appl. No.: 18/059,562

(22) Filed: Nov. 29, 2022

Related U.S. Application Data
(60) Provisional application No. 63/264,929, filed on Dec. 3, 2021.

(51) Int. Cl. B67D 1/08; A47J 31/44; A47J 31/60

(52) U.S. Cl. CPC B67D 1/0894; A47J 31/4425; A47J 31/60

(57) ABSTRACT

A revolving beverage holder may position a first opening of a revolving beverage holder under a dispensing point of a machine. The revolving beverage holder may receive a component of a drink from the machine with a vessel positioned within the first opening. The revolving beverage holder may automatically rotate a plate to position a vessel in a second opening of the revolving beverage holder under the dispensing point of the machine.

### INCORPORATION BY REFERENCE TO ANY PRIORITY APPLICATIONS

This application claims priority benefit of U.S. Provisional Patent Application No. 63/264,929 filed Dec. 3, 2021, and titled, “REVOLVING BEVERAGE HOLDER”, which is incorporated herein by reference in its entirety.

Any and all application for which a foreign or domestic priority claim is identified in the Application Data Sheet as filed with the present application are hereby incorporated by reference under 37 CFR 1.57

### BACKGROUND

### Field

The present disclosure relates to systems and methods for receiving and holding a beverage, such as, in certain embodiments, systems and methods for receiving a beverage, holding a beverage, and rotating the beverage into various positions.

### Description of the Certain Related Art

Certain beverages are prepared with components that can be dispensed from a machine or apparatus, such as espresso, brewed liquid (e.g., coffee or tea), foam, steamed liquids, raw ingredients, or other ingredients. These components can be dispensed and held for a period of time until ready to be incorporated into a beverage. A user can also be required to wait while these components are dispensed to be incorporated into a beverage.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

In some embodiments, a method for dispensing a component for a beverage, can include positioning a first opening of a revolving beverage holder under a dispensing point of a machine; receiving the component from the machine with a vessel positioned within the first opening; automatically rotating the revolving beverage holder to position a second opening of the revolving beverage holder under a dispensing point of a machine.

In some embodiments, the method can include initiating dispensing of the component from the machine into the vessel.

In some embodiments, the method can include receiving a beverage order and initiating dispensing of the component for the beverage based on the beverage order.

In some embodiments, the method can include determining a dispensing time of when the component is dispensed into the vessel positioned within the first opening.

In some embodiments, the method can include: determining a holding time of the component based on the dispensing time; comparing the holding time to a threshold; determining that the holding time has exceeded the threshold; providing an alarm to notify a user the threshold has been exceeded.

In some embodiments, the method can include determining the vessel is positioned underneath the dispensing point.

In some embodiments, the method can include determining the vessel is empty.

In some embodiments, the method can include dispensing a gas into the vessel, wherein the gas is heavier than ambient air.

In some embodiments, the method can include heating the component and the vessel in the revolving beverage holder.

In some embodiments, the vessel can include an opening with a smaller diameter than a remainder of the vessel.

In some embodiments, the method can include, during a rinse cycle, moving the revolving beverage holder away from the dispensing point and dispensing rinsing material from the dispensing point.

In some embodiments, the method can include, during a rinse cycle, rotating the revolving beverage holder such that a vessel is not positioned under the dispensing point and dispensing rinsing material from the dispensing point.

In some embodiments, a revolving beverage holder can include: a first plate including a plurality of openings; and a second plate spaced from and positioned beneath the first plate; wherein the plurality of openings are each configured to receive a vessel for a component for a beverage.

In some embodiments, the first plate can be circular.

In some embodiments, the revolving beverage holder can include a stand configured to position the revolving beverage holder underneath a dispensing point of a machine.

In some embodiments, the revolving beverage holder can include a dispenser configured to dispense a gas.

In some embodiments, the revolving beverage holder can include a heating system configured to heat the vessel.

In some embodiments, a system for dispensing and receiving an ingredient or component of a beverage can include: a beverage dispensing machine including a dispensing point; a revolving beverage holder including a plurality of openings that are configured to receive a vessel for the ingredient or component of the beverage; an actuator configured to rotate the revolving beverage holder; a control system configure to position a first opening of the revolving beverage holder under the dispensing point of beverage dispensing machine; dispensing the ingredient or component from the beverage dispensing machine into a vessel positioned within the first opening; and rotating the revolving beverage holder to position a second opening of the revolving beverage holder under the dispensing point of the beverage dispensing machine.

In some embodiments, the system can include a heating system configured to heat the vessel.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1A illustrates a perspective view of an embodiment of a revolving beverage holder positioned under a machine or apparatus that dispenses an ingredient or component of a beverage.

FIG. 1B illustrates a perspective view of an embodiment of a revolving beverage holder positioned a distance away from a machine or apparatus that dispenses an ingredient or component of a beverage.

FIG. 2A illustrates a perspective view of an embodiment of a revolving beverage holder.

FIG. 2B illustrates an exploded view of an embodiment of a revolving beverage holder.

FIG. 3 schematically illustrates a top view of an embodiment of a revolving beverage holder.

FIG. 4 illustrates a perspective view of an embodiment of a revolving beverage holder positioned under a machine or apparatus that dispenses an ingredient or component of a beverage.

FIG. 5 illustrates a method of using an embodiments of a revolving beverage holder.

FIG. 6 illustrates a schematic of a control system of an embodiments of a revolving beverage holder.

### DETAILED DESCRIPTION

Various extraction systems and methods are described below to illustrate various examples that may achieve one or more desired improvements. These examples are only illustrative and not intended in any way to restrict the general disclosure presented and the various aspects and features of this disclosure. The general principles described herein may be applied to embodiments and applications other than those discussed herein without departing from the spirit and scope of the disclosure. Indeed, this disclosure is not limited to the particular embodiments shown, but is instead to be accorded the widest scope consistent with the principles and features that are disclosed or suggested herein. For example, many of the embodiments are described in the context of receiving, holding, and revolving espresso. However, certain features and aspects of the disclosure may also have utility in producing other components for a beverage, such as brewed coffee or tea, foam, steamed liquids, raw ingredients, or other ingredients. Additionally, certain features and aspects of the disclosure may also have utility in producing beverages, such as brewed coffee beverages, tea beverages, or other types of beverages.

An aspect of the present disclosure is the recognition that components, such as espresso, brewed liquid (e.g., coffee or tea), foam, steamed liquids, raw ingredients, or other ingredients, can have a short shelf life. Therefore, it can be desirable to incorporate the component into the beverage shortly after being dispensed. For example, it can be desirable to incorporate the component into the beverage shortly after being dispensed to maintain the texture, flavor, temperature, or other characteristic of the component. Once dispensed, the quality of the component can begin to degrade due to various reasons, such as changes in temperature or due to the chemical composition of the component. For example, it can be desirable to maintain the crema layer of small bubbles at the top of an espresso shot.

However, the processing of the components, such as pulling a shot of espresso or brewing a serving of coffee or creating foam can be time consuming and complex. It can be desirable to process and dispense the component and hold them for a period of time. This can increase the availability of the components or ingredients and avoid or reduce wait times for preparation of the beverage. For example, pulling a shot of espresso can take more than 20 seconds, which can slow down beverage production.

Additionally, it can take time for a user to move the vessel, such as a container or cup, from a dispensing point of the machine or apparatus and place an empty vessel under the dispensing point. This can prevent another component from being dispensed until the filled vessel is removed and an empty vessel is placed under the dispensing point. This can create operation inefficiencies for users to coordinate positioning an empty vessel, removing the vessel once filled, and positioning an empty vessel from the dispensing point of the machine or apparatus.

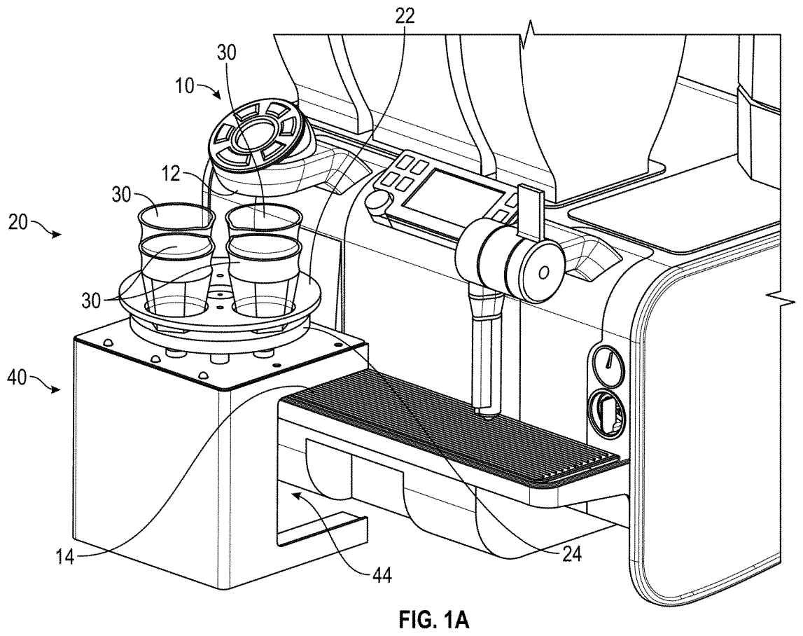

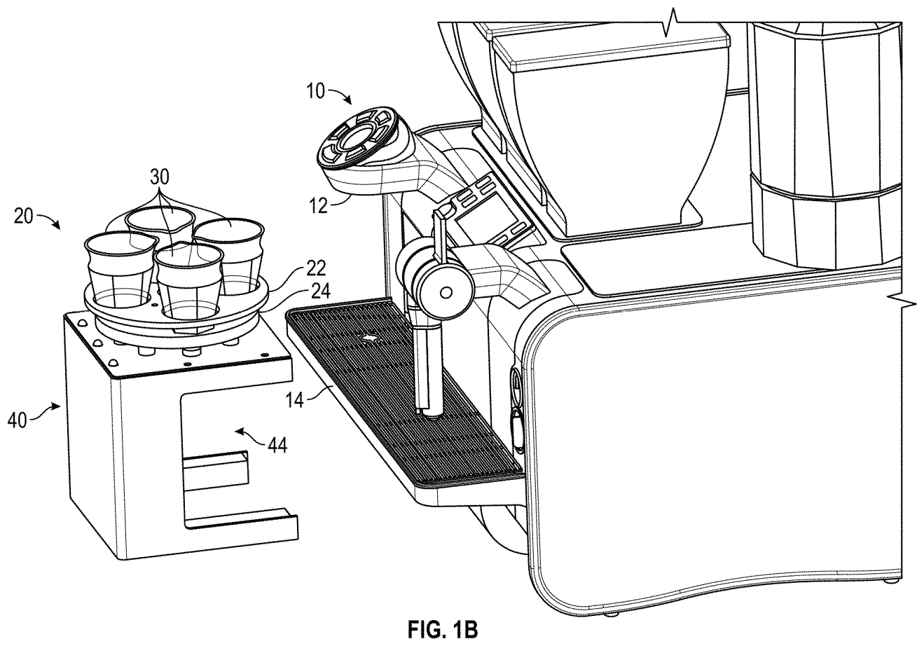

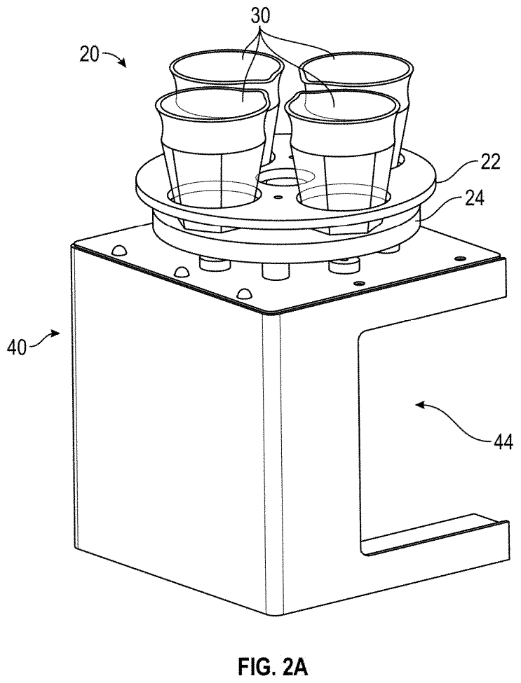

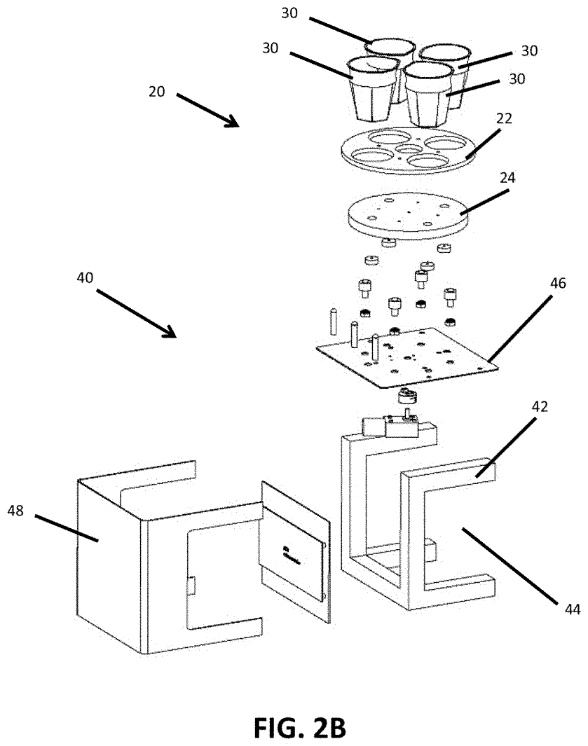

FIGS. 1A-1B and 2A-2B illustrate perspective views of an embodiment of a revolving or rotating beverage holder 20. The revolving beverage holder 20 can have a first plate 22 with a plurality of openings 26. Each of the openings 26 can extend through a thickness or height of the first plate 22. Each of the plurality of openings 26 can be shaped and dimensioned to receive a vessel 30, which can be a container or cup to receive a component for a beverage. In some examples, each of the openings 26 can be round, circular, oblong, oval, square, rectangular, or triangular. The first plate 22 can have any number of openings, such as 2, 3, 4, 5, 6, 7, 8, 9, or 10 and in certain embodiments between 2 and 10 openings and in certain embodiments between 4 and 8 openings. The revolving beverage holder 20 can also have a second plate or base 24. The second plate 24 can be configured to support each of the vessels 30 received in the plurality of openings. The second plate 24 can be spaced from and positioned beneath the first plate 22. The second plate 24 can be spaced from the first plate 22 at a distance to accommodate a height of the vessel 30 received within the openings 26 of the first plate 22, such that the second plate 24 receives the bottom of the vessel 30 and the top of the vessel 30 extends above the first plate 22. In this manner, the first plate 22 can hold or maintain each vessel 30 in position on the revolving beverage holder 20. The first plate 22 and the second plate 24 can have a number of shapes, such as round shapes, circular, oblong, oval, square, rectangular, or triangular. The revolving beverage holder 20 can include a motor configured to rotate the first plate 22 and/or the second plate 24 about a central axis.

In some examples, the first plate 22 and the second plate 24 can be equal sizes, such as with equal outer diameters and equal thicknesses or heights. In other examples, the first plate 22 can be greater than the second plate 24, such as the first plate 22 having an outer diameter greater than the outer diameter of the second plate or such that the first plate 22 having a thickness or height that is greater than a thickness of height of the second plate 24. In some examples, the first plate 22 can be smaller than the second plate 24, such as the first plate 22 having an outer diameter smaller than the outer diameter of the second plate or such that the first plate 22 having a thickness or height that is smaller than a thickness of height of the second plate 24.

The revolving beverage holder 20 can be positioned under a machine 10 or apparatus that dispenses an ingredient or component of a beverage so as to form a system for dispensing and receiving an ingredient or component of a beverage. As shown in FIG. 1A, the revolving beverage holder 20 can be positioned under an espresso machine 10. The revolving beverage holder 20 can be positioned such that a vessel 30 is positioned underneath a dispensing point 12 of the machine 10, such that the machine 10 can dispense a component for a beverage (such as an espresso shot) into a vessel 30 held by the revolving beverage holder 20. The machine 10 can be an espresso machine as illustrated or can be other forms of beverage dispensing apparatus such as a machine that provides brewed coffee and/or heated milk.

As shown in FIGS. 1A-1B and 2A-2B, the revolving beverage holder 20 can further include a stand 40. As shown in FIG. 2A-2B, the stand 40 can include a frame 42 with a cover 48. The stand 40 can define at least three sides to define an opening 44. The cover can cover three sides of the frame 42. The opening 44 can extend from one end of the frame 42 to an opposing end of the 42. For example, the opening 44 can extend from one side of the stand 40 to an opposing side of the frame 40. The stand 40 can also include a mounting plate 46 on a top surface of the frame 42. The mounting plate 46 can be configured to receive and secure the second plate 24.

As shown in FIG. 1A-1B, the stand 40 can support and position the revolving beverage holder to position the first plate 22 at a height so the vessels 30 can each be positioned underneath and close to the dispensing point 12 of the machine 10. The use of the stand 40 can advantageously prevent splashing or spillage when dispensing the component into the vessel 30. The stand 40 can include an opening 44 to accommodate features of the machine 10 and thus allow the revolving beverage holder 20 to be positioned at the dispensing point 12. For example, the machine 10 can include a tray 14 that is configured to receive a vessel 30 to be positioned under the dispensing point 12. The stand 40 can have an opening 44 to receive or accommodate the tray 14 and thus allow the revolving beverage holder 20 to be positioned directly under the dispensing point 12 of the machine 10. The stand 40 can be positioned such that the mounting plate 40 supporting the first plate 22 and the second plate 24 can be positioned over the tray 14 and beneath the dispensing point 12 of the machine 10. The stand 40 can have other openings or shapes to accommodate features of the machine 10 that may interfere with positioning of the revolving beverage holder 20 in the desired position. For example, the stand 40 can be configured to allow use of access to a grounds drawer, steam valves, cleaning operations, or other features.

Additionally, the revolving beverage holder 20 can be removable, such that it can be moved into place at the machine 10, such as shown in FIG. 1A, and moved away from the machine 10 when desired, such as shown in FIG. 1B. In some examples, the stand 40 can have wheels or other features that allow the revolving beverage holder 20 to be moved easily. In this manner, the stand 40 can position the revolving beverage holder 20 when a user wants to use the revolving beverage holder 20. The revolving beverage holder 20 can also be positioned or removed without interfering with the normal function and operation of the machine 10 without the revolving beverage holder 20.

The revolving beverage holder 20 can be configured to rotate or revolve. The first plate 22 and the second plate 24 can be configured to rotate together. The first plate 22 can be configured to rotate relative to the second plate 24. The rotation of the revolving beverage holder 20 allows the revolving beverage holder 20 to position a vessel 30 held in one of the openings 26 to be positioned under the dispensing point 12 of the machine 10. Once the dispensed component is received within the vessel 30, the revolving beverage holder 20 can then rotate to position the next vessel 30 in an adjacent opening 26 under the dispensing point 12 of the machine. This also moves the first vessel 30 into a position out from underneath the dispensing point 12, allowing a user to access the first vessel 30 more easily. The rotation of the revolving beverage holder 20 also allows the user to pour out the dispensed component from the first vessel 30 from the first opening 26. The user can then place an empty vessel 30 into the first opening 26, which can be the first vessel once emptied and rinsed out or a different vessel. During this process of removing and replacing the vessel with an empty vessel, the machine 10 can advantageously continue to dispense a component into the next vessel, such as a second vessel 30 in a second opening 26. The rotation of the revolving beverage holder 20 can advantageously increase the availability of an empty vessel to receive a component whenever the machine 10 is ready to dispense the next component. The rotation of the revolving beverage holder 20 can advantageously increase the availability of a dispensed component to the user to incorporate the component into a beverage and reduce potential delay in waiting for components to be dispensed.

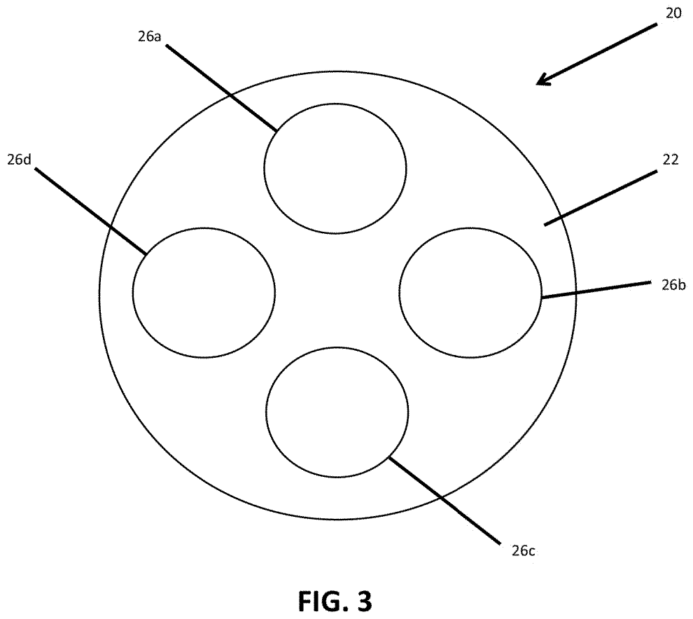

FIG. 3 schematically illustrates a top view of an embodiment of a revolving beverage holder 20. The revolving beverage holder 20 can include a first plate 22 with a plurality of openings 26. The first plate 22 can have any number of openings, such as 2, 3, 4, 5, 6, 7, 8, 9, or 10 and in certain embodiments between 2 and 10 openings and in certain embodiments between 4 and 8 openings. As shown in FIG. 3, the first plate 22 can have four openings 26a, 26b, 26c, 26d. Each of the openings 26a, 26b, 26c, 26d can be shaped and dimensioned to receive a vessel, which can be a container or cup to receive a component for a beverage. The first plate 22 can hold or maintain a plurality of vessels 30, such as 1, 2, 3, or 4 vessels 30 (which in certain embodiments can correspond to the number of openings in the plate 22), in position on the revolving beverage holder 20. The first plate 22 can have a number of shapes, such as round shapes, circular, oblong, oval, square, rectangular, or triangular. As shown in FIG. 3, the first plate 22 can be circular.

The revolving beverage holder 20 can be configured to rotate or revolve. The revolving beverage holder 20 can be positioned under a dispensing point of a machine or apparatus, such that a first vessel held in one of the openings, such as a first opening 26a, can be positioned under the dispensing point of the machine or apparatus. The machine or apparatus can then dispense a component for a beverage from the dispensing point to a vessel positioned beneath it. Once dispensed into the first vessel in the first opening 26a, the revolving beverage holder 20 can rotate and index to the next position, such that a second vessel in the second opening 26b is positioned under the dispensing point. The machine or apparatus can then dispense a second component into the second vessel in the second opening 26b. This dispensing and rotation can be repeated with a third vessel in a third opening 26c and the fourth vessel in a fourth opening 26d.

Once a component has been dispensed into a vessel, the revolving beverage holder 20 can rotate, such that the vessel is no longer positioned underneath the dispensing point and the vessel is available to be removed from the revolving beverage holder 20. For example, after a component is dispensed in the first vessel, the revolving beverage holder 20 can rotate and the first vessel in the first opening 26a can be available to be removed from the first position 26a. The component held within the first vessel can then be incorporated into a beverage or can be disposed. The first vessel can then be rinsed out and placed back into the first opening 26a or replaced with a different empty vessel. Similarly, each of the vessels can be held in the revolving beverage holder 20 in their respective opening, until the user is ready to incorporate the component into a beverage. Once an empty vessel has been positioned in the respective opening, the revolving beverage holder 20 can continue to rotate to position the next empty vessel underneath the dispensing point of the machine.

During this process of removing and replacing the vessel with an empty vessel, the use of the revolving beverage holder 20 can advantageously increase the number of empty vessels to receive a dispensed component. The rotation of the revolving beverage holder 20 can advantageously increase the availability of empty vessels to receive a component when the machine is ready to dispense the next component. This process can therefore reduce the potential delay in preparing the next beverage by increasing the frequency of components dispensed into a plurality of vessels. This process also increases the availability of components for when the user is ready to incorporate the component into a beverage. This can reduce any potential delay in preparing the next beverage by increasing the availability of components dispensed into a plurality of vessels and decrease waiting time for components to be dispensed.

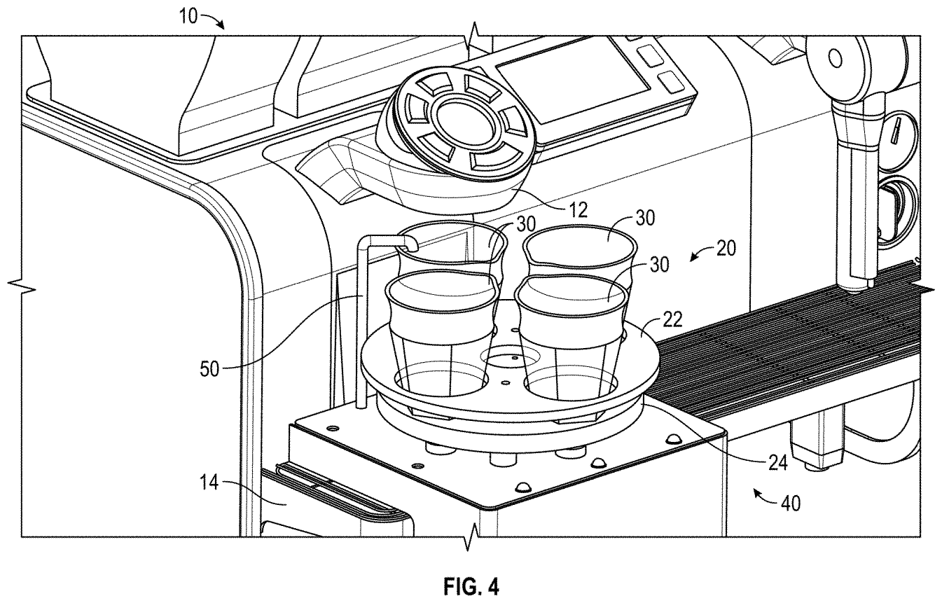

Additional features or provisions can prolong the quality of the dispensed component. For example, the temperature of the vessels and/or the components can be controlled, such as through a heating or cooling system. For example, the first plate 22 or the second plate 24 can include a heater to maintain the vessels and components positioned therein at a certain temperature. In another example, the exposure of the component within the vessels to air can be limited. The specific vessel geometry can result in a small surface area of the espresso that is exposed to air. For example, each of the vessels can have an opening with a smaller diameter compared to the base of the vessel, a maximum diameter of the vessel, or a remainder of the vessel. In another example, a gas can be poured into the vessel. The gas can be heavier or have an increased density compared to air or ambient air. In this manner, when the gas is dispensed into a vessel, the gas can create a protective blanket or layer of gas. The protective layer of gas can be positioned on the top surface or above the dispensed component to eliminate exposure to air. The gas can retard oxidation or other chemical changes in the component in order to prolong the shelf life of the component. In some examples, the machine or apparatus configured to dispense the component can also dispense the gas. In some examples, the machine or apparatus includes a source of the gas and/or is connected to a gas supply. In some examples, the gas can include nitrogen, argon, carbon dioxide, hydrogen, nitrous oxide, and/or any other gas and certain embodiments the gas can include nitrogen, argon, carbon dioxide, hydrogen, nitrous oxide in percentage amount greater than ambient air. In some examples, the revolving beverage holder 20 can include a dispenser 50 configured to dispense an additional component, such as a gas. As shown in FIG. 4, the stand 40 can include a dispenser 50. The dispenser 50 can be positioned to dispense an additional component into one of the vessels 30 positioned in the openings 26 of the revolving beverage holder 20. In some examples, the dispenser 50 can be positioned to dispense into the vessel 30 also positioned under a dispensing point 12 of a machine or apparatus 10, as shown in FIG. 4. In other examples, the dispenser can be positioned to dispense into a vessel 30 when not positioned under the dispensing point 12 of a machine or apparatus. The dispenser 50 can be configured to move, such as rotate, to be adjusted into various positions relative to the various openings 26 of the revolving beverage holder 20. The additional component, such as a gas, can be dispensed in the vessel before, during, or after the component is dispensed.

The revolving beverage holder 20 can be configured to automatically rotate once a component has been dispensed into an empty vessel. The revolving beverage holder 20 can then automatically rotate to the next empty vessel to receive a dispensed component. The revolving beverage holder 20 can also be controlled manually, such that a user may initiate and control rotation of the revolving beverage holder 20.

In some examples, the revolving beverage holder 20, can be configured to communicate with a point of sale system, such that the revolving beverage holder 20 can receive information regarding the beverage order, including details regarding the component required for the specific beverage. For example, the revolving beverage holder can receive information regarding the size, number, or type of component needed. For example, the revolving beverage holder 20 can be configured to receive information regarding the shots, the type of espresso or bean, or the size of the espresso shot. The revolving beverage holder 20 can use the information regarding the beverage order to the machine or apparatus configured to dispense the desired one or more components for a particular beverage order. The revolving beverage holder 20 can also use the information to keep track of which one or more components corresponds to a particular beverage order.

The revolving beverage holder 20 can also be in communication with the machine or apparatus configured to dispense the component. The revolving beverage holder 20 can also communicate with the machine to initiate dispensing of the component once an empty vessel is placed underneath the dispensing point of the machine. The revolving beverage holder 20 can then automatically rotate to index to the next empty vessel. The revolving beverage holder 20 can then initiate dispensing of the next component into the next empty vessel by communicating with the machine.

The revolving beverage holder 20 can also receive information regarding the quality of the component dispensed. The revolving beverage holder 20 can determine the quality of the component dispensed. The quality information can also come from the machine or apparatus dispensing the component. If the quality of the dispensed component is not sufficient, the revolving beverage holder 20 or the machine can initiate dispensing of the same component again into the next empty vessel. The revolving beverage holder 20 can also show an indication or alarm that the component is low quality or cannot be used. For example, the indication or alarm can be shown with an indicator (such an LED indicator) or on a user interface.

The revolving beverage holder 20 can also determine or receive information related to timing of a particular opening, such as when a component is dispensed into a vessel (e.g., the dispensing time), how long the component resides in the vessel (e.g., the holding time), when a vessel has been removed, when an empty vessel has been placed into the opening. The revolving beverage holder 20 can also compare this dispensing time or holding time to a threshold. If the dispensing time or the holding time exceeds a threshold, the revolving beverage holder can show an indication or alarm that the component has exceeded the threshold and cannot be used. For example, the indication or alarm can be shown with an indicator (such an LED indicator) or on a user interface. The tracking of these times can allow the revolving beverage holder 20 to predict or coordinate when to initiate the dispensing of the next component. This can minimize the holding time of each of the components but also decrease potential wait times or delay for the component in producing a beverage. The revolving beverage holder 20 keeping track of the holding times for components can be used for creating algorithms to more accurately predict when the next component should be dispensed. This can minimize the holding time to increase the quality of components incorporated into beverages. This can also decrease wait times or delays to prevent requiring users to wait for the component to be dispensed.

The revolving beverage holder 20 can also include one or more sensors. The one or more sensors can include one or more of a pressure sensor, a flow sensor, a weight sensor, a light sensor, a temperature or heat sensor, a proximity sensor, or other types of sensors. The sensors can be used to determine the quality of the component produced. The sensors can also be used to prevent injury or accidents with use of the revolving beverage holder 20. The revolving beverage holder 20 can have a sensor to detect when one of the vessels has been removed from a particular opening. The revolving beverage holder 20 can then prevent the machine from dispensing into a particular opening without a vessel present, even if the opening is positioned under the dispensing point. The revolving beverage holder 20 can include a sensor to detect when a particular vessel has been filled with something, such as with a dispensed component. The revolving beverage holder 20 can then prevent the machine from dispensing into the filled vessel, even if the vessel is positioned under the dispensing point of the machine. The revolving beverage 20 can also detect when a vessel or an empty vessel is positioned underneath the dispensing point of the machine. The revolving beverage holder 20 can then ensure the machine only dispenses when a vessel or an empty vessel is positioned underneath the dispensing point of the machine.

In some examples, the revolving beverage holder 20 can have a user interface. The user interface can be configured to display information related to any of the vessels or openings of the revolving beverage holder 20. The user interface can be configured to display notifications, alarms or indicators associated with any one or more of the openings or with the revolving beverage holder 20. For example, the user interface can display which of the plurality of openings holds a vessel and whether the vessel is empty. The user interface can also display the status of the machine, such as if a component has been recently dispensed, is currently being dispensing, or preparing to be dispensed. The user interface can display information regarding the beverage order or corresponding components, such as a bean type indication, the quality of the component, the holding time of the component, whether the component can be incorporated into beverage (such as based on the quality or the holding time). The user interface can also display the status of the revolving beverage holder 20, such as the number of openings occupied with a vessel or an empty vessel or the number of components waiting.

The user interface can also allow a user to control the revolving beverage holder 20. For example, the user interface can allow a user to change the direction of rotation for a user (such as clockwise or counterclockwise). The user interface can allow a user to control the positions of the openings 26 relative to the machine. For example, the user interface can allow a user to select a particular opening 26 to be positioned under a dispensing point.

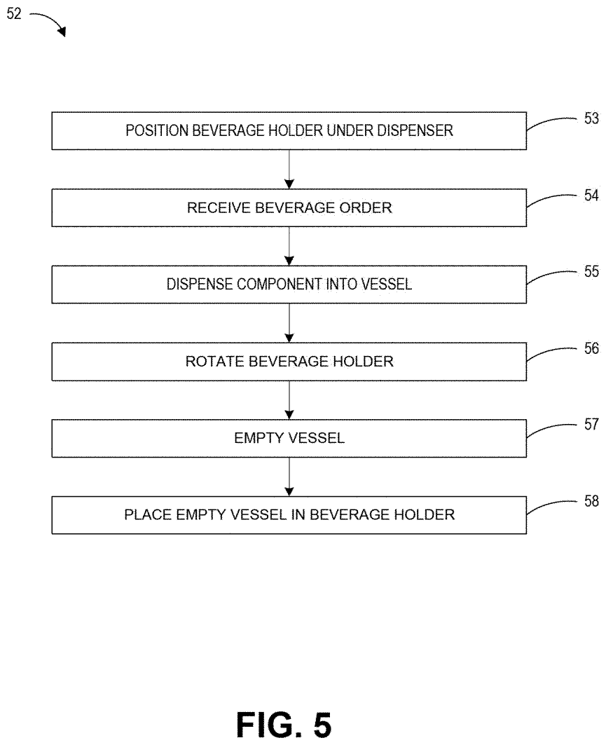

FIG. 5 illustrates a method 52 of using a revolving beverage holder 20. As in FIG. 5, at step 53, a user can position the revolving beverage holder 20 under a dispensing point 12 of a machine 10, as shown in FIG. 4. In some embodiments, the user can position a first opening 26a of the revolving beverage holder 20 under the dispensing point 12 of the machine 10. In some embodiments, the user can place or position a vessel 30 in the first opening 26a before or after the user positions the first opening 26a under the dispensing point 12. In some embodiments, the machine 10 and/or the revolving beverage holder 20 can automatically determine if the first opening 26a is under the dispensing point via one or more sensors of the revolving beverage holder 20.

In some embodiments, after the user positions the revolving beverage holder 20 at step 53, the user, the machine 10, and/or the revolving beverage holder 20 can receive a beverage order at step 54. In some embodiments, the user can receive the beverage order from a point of sale system enter the beverage order into the machine 10. In some embodiments, the machine 10 can receive the beverage order from the point of sale system. In some embodiments, the revolving beverage holder 20 can receive the beverage order or both the beverage holder 20 and the machine 10 can receive the beverage order. The revolving beverage holder 20 can communicate the received beverage order to the machine 10.

In some embodiments, after the user, the machine 10, and/or the revolving beverage holder 20 receive the beverage order at step 54, the machine 10 can dispense at least a component of a beverage of the beverage order at step 55, and the vessel 30 can receive at least the component of the beverage. In some embodiments, the user can initiate dispensing of at least the component of the beverage. In some embodiments, the revolving beverage holder 20 can communicate with the machine 10 to initiate dispensing of at least the component of the beverage. In some embodiments, the machine 10 can automatically initiate dispensing of at least the component of the beverage order. In some embodiments, a dispenser 50 of the revolving beverage holder 20 can dispense an additional component, such as gas, into the vessel 30 before, during, or after at least the component of the beverage is dispensed.

In some embodiments, before the machine 10 dispenses at least the component of the beverage, the machine 10 and/or the revolving beverage holder 20 can automatically determine if the vessel 30 is empty via one or more sensors of the revolving beverage holder 20. If the vessel 30 is not empty, the revolving beverage holder 20 can prevent the machine 10 from dispensing at least the component of the beverage.

After the vessel 30 receives at least the component of the beverage at step 55, the revolving beverage holder 20 can rotate at step 56. In some embodiments, the user can rotate a first plate 22 and/or a second plate 24 of the revolving beverage holder 20. In some embodiments, the revolving beverage holder 20 can automatically rotate the first plate 22 and/or the second plate 24 via one or more actuators (e.g., a motor). The user and/or the revolving beverage holder 20 can rotate the first plate 22 and/or the second plate 24 so a second opening 26b and/or a second vessel 30 is positioned under the dispensing point 12 of the machine 10.

In some embodiments, before the revolving beverage holder 20 automatically rotates the first plate 22 and/or the second plate 24, the revolving beverage holder 20 can automatically determine if the vessel 30 received at least the component of the beverage. The revolving beverage holder 20 can automatically determine if the vessel 30 received at least the component of the beverage via a weight sensor and/or by determining if a dispensing time of at least the component of the beverage has passed.

In some embodiments, after the revolving beverage holder 20 rotates at step 56, the user can empty the vessel 30 at step 57. In some embodiments, the revolving beverage holder 20 can receive a holding time of at least the component of the beverage and/or the revolving beverage holder 20 can automatically determine a holding time of at least the component of the beverage based on at least the component type, a weight of the component, a temperature of the component, and/or any other component characteristics. If the user does not empty the vessel 30 before the holding time passes, the revolving beverage holder 20 can show an indication (i.e., an LED) or alarm or on a user interface that the at least component has exceeded a threshold holding time and cannot be used. In some embodiments, the revolving beverage holder 20 can heat the vessel 30 until the user empties the vessel 30 and/or the at least component has exceeded the threshold holding time.

In some embodiments, after the user empties the vessel 30 at step 57, the user can place an empty vessel 30 in the first opening 26a. In some embodiments, the empty vessel 30 can be the vessel 30 that contained the at least component of the beverage, or the empty vessel 30 can be a different vessel 30.

In some embodiments, the machine 10 can periodically perform a rinse cycle to rinse one or more components of the machine 10. The rinse cycle can rinse fluid lines that dispense beverage components. In some embodiments, the machine 10 can periodically perform the rinse cycle after a period of time of 1 min, 2 mins, 3 mins, 4 mins, 5 mins, 6 mins, 7 mins, 8 mins, 9 mins, 10 mins, 15 mins, about 20 mins, and/or any value between the aforementioned values or about the aforementioned values. In some embodiments, the machine 10 can perform the rinse cycle if the machine 10 has not dispensed a beverage component for 1 min, 2 mins, 3 mins, 4 mins, 5 mins, 6 mins, 7 mins, 8 mins, 9 mins, 10 mins, 15 mins, 20 mins, and/or any value between the aforementioned values or about the aforementioned values.

In some embodiments, the revolving beverage holder 20 can show an indication (i.e., an LED) or alarm or on a user interface that the machine 10 will perform and/or is performing the rinse cycle. In some embodiments, the user can rotate the plates 22, 24 or move a vessel 30 and/or the revolving beverage holder 20 so the vessel 30 and/or the revolving beverage holder 20 is not positioned under the dispensing point 12 of the machine 10 so rinsing material (e.g., rinsing water) from the rinse cycle can go down a tray 14 of the machine 10. In some embodiments, the revolving beverage holder 20 can automatically rotate the plates 22, 24 or otherwise move the revolving beverage holder 20 so the vessel 30 and/or the revolving beverage holder 20 is not positioned under the dispensing point 12 of the machine 10 so rinsing material (e.g., rinsing water) from the rinse cycle can go down a drip tray of the machine 10.

In some embodiments, after the rinse cycle, the user, or the revolving beverage holder 20 can rotate the plates 22, 24 and/or move the revolving beverage holder 20 so the vessel 30 and/or the revolving beverage holder 20 is positioned under the dispensing point 12 of the machine 10.

Optionally, in some embodiments, the revolving beverage holder 20 can periodically perform a rinse cycle to rinse the dispenser 50. In some embodiments, the revolving beverage holder 20 can periodically perform the rinse cycle after a period of time of 1 min, 2 mins, 3 mins, 4 mins, 5 mins, 6 mins, 7 mins, 8 mins, 9 mins, 10 mins, 15 mins, 20 mins, and/or any value between the aforementioned values or about said values. In some embodiments, the revolving beverage holder 20 can perform the rinse cycle if the dispenser 50 has not dispensed an additional component for 1 min, 2 mins, 3 mins, 4 mins, 5 mins, 6 mins, 7 mins, 8 mins, 9 mins, 10 mins, 15 mins, 20 mins, and/or any value between the aforementioned values or about said values. In some embodiments, the revolving beverage holder 20 can show an indication (i.e., an LED) or alarm or on a user interface that the revolving beverage holder 20 will perform and/or is performing the rinse cycle. In some embodiments, the user can rotate the plates 22, 24 or move a vessel 30 and/or the revolving beverage holder 20 so the vessel 30 is not positioned under the dispenser 50 so rinsing material (e.g., rinsing water) from the rinse cycle can go down a drip tray. In some embodiments, the revolving beverage holder 20 can automatically rotate the plates 22, 24 so the vessel 30 is not positioned under the dispenser 50 so rinsing material (e.g., rinsing water) from the rinse cycle can go down a drip tray. In some embodiments, after the rinse cycle, the user, or the revolving beverage holder 20 can rotate the plates 22, 24 so the vessel 30 is positioned under the dispenser 50. In some embodiments, the machine 10 and the revolving beverage holder 20 can each perform the rinse cycle at the same time or at different times.

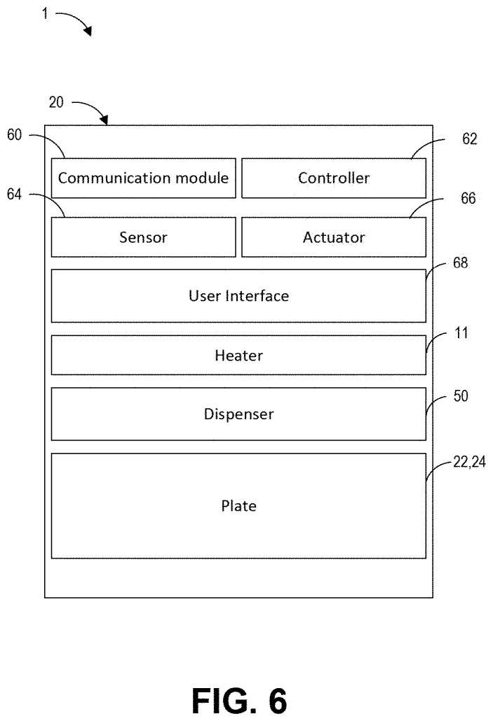

FIG. 6 illustrates a schematic illustration of a system 1 for dispensing and receiving an ingredient or component of a beverage which can include a control system for moving or revolving beverage holder 20. The control system can include a communication module 60, a controller 62, at least one sensor 64, at least one actuator 66, and/or a user interface 68. The communication module 60 can wirelessly or via a wired connection communicate with a point of sale system and/or a machine 10. The controller 62 can determine a dispensing time and/or a holding time. The controller 62 can control any of the functions described above with reference to FIGS. 1-6 of a heater 11 of the revolving beverage holder 20, the dispenser 50, the at least one sensor 64, the at least one actuator 66, the user interface 68 and/or the plates 22, 24. The controller 62 can turn on/off the heater of the revolving beverage holder 20. The controller 62 can receive information from the at least one sensor 64 and/or the communication module 60. The controller 62 can use the information to initiate dispensing of a component of a drink order, initiate dispensing of an additional component from the dispenser 50, rotate the plates 22, 24 via the at least one actuator 66, show an indication (i.e., an LED, on the user interface 68, etc.) or an alarm, determine a dispensing time, determine a holding time, and/or any other functions of the revolving beverage holder 20 disclosed herein. The at least one sensor 64 can be any of the sensors as described herein with reference to FIGS. 1-5. The user interface 68 can display any of the information received by the controller 62 from the at least one sensor 64 and/or the at least one sensor 64 and/or any other information determined by the controller 62.

### Certain Terminology

As used herein, the term “beverage” has its ordinary and customary meaning, and includes, among other things, any edible liquid or substantially liquid substance or product having a flowing quality (e.g., juices, coffee beverages, teas, milk, beer, wine, cocktails, liqueurs, spirits, cider, soft drinks, flavored water, energy drinks, soups, broths, combinations of the same, or the like).

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

The following example embodiments identify some possible permutations of combinations of features disclosed herein, although other permutations of combinations of features are also possible.

### SUMMARY

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable. In addition, although this disclosure describes certain embodiments and examples of beverage systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a sub combination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage dispensing systems and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. A method for dispensing a component for a beverage, the method comprising:
positioning a first opening of a revolving beverage holder under a dispensing point of a machine;
receiving the component from the machine with a vessel positioned within the first opening;
automatically rotating the revolving beverage holder to position a second opening of the revolving beverage holder under a dispensing point of a machine.

2. The method of claim 1, further comprising initiating dispensing of the component from the machine into the vessel.

3. The method of claim 1, further comprising receiving a beverage order and initiating dispensing of the component for the beverage based on the beverage order.

4. The method of claim 1, further comprising determining a dispensing time of when the component is dispensed into the vessel positioned within the first opening.

5. The method of claim 4, further comprising:
determining a holding time of the component based on the dispensing time;
comparing the holding time to a threshold;
determining that the holding time has exceeded the threshold;
providing an alarm to notify a user the threshold has been exceeded.

6. The method of claim 1, further comprising determining the vessel is positioned underneath the dispensing point.

7. The method of claim 6, further comprising determining the vessel is empty.

8. The method of claim 1, further comprising dispensing a gas into the vessel, wherein the gas is heavier than ambient air.

9. The method of claim 1, further comprising heating the component and the vessel in the revolving beverage holder.

10. The method of claim 1, wherein the vessel comprises an opening with a smaller diameter than a remainder of the vessel.

11. The method of claim 1, further comprising during a rinse cycle, moving the revolving beverage holder away from the dispensing point and dispensing rinsing material from the dispensing point.

12. The method of claim 1, further comprising during a rinse cycle, rotating the revolving beverage holder such that a vessel is not positioned under the dispensing point and dispensing rinsing material from the dispensing point.

13. A revolving beverage holder, comprising:
a first plate comprising a plurality of openings; and
a second plate spaced from and positioned beneath the first plate;
wherein the plurality of openings are each configured to receive a vessel for a component for a beverage.

14. The revolving beverage holder of claim 13, wherein the first plate is circular.

15. The revolving beverage holder of claim 13, further comprising a stand configured to position the revolving beverage holder underneath a dispensing point of a machine.

16. The revolving beverage holder of claim 13, further comprising a dispenser configured to dispense a gas.

17. The revolving beverage holder of claim 13, further comprising a heating system configured to heat the vessel.

18. A system for dispensing and receiving an ingredient or component of a beverage, the system comprising:
a beverage dispensing machine including a dispensing point;
a revolving beverage holder including a plurality of openings that are configured to receive a vessel for the ingredient or component of the beverage;
an actuator configured to rotate the revolving beverage holder;
a control system configure to position a first opening of the revolving beverage holder under the dispensing point of beverage dispensing machine; dispensing the ingredient or component from the beverage dispensing machine into a vessel positioned within the first opening; and rotating the revolving beverage holder to position a second opening of the revolving beverage holder under the dispensing point of the beverage dispensing machine.

19. The system of claim 18, comprising a heating system configured to heat the vessel.
